(19) United States
(12) Patent Application Publication
(10) Pub. No.: US 2025/0266191 A1
(43) Pub. Date: Aug. 21, 2025

(54) THIN FILM RESISTOR AND METHOD OF FABRICATING THE SAME

(71) Applicant: YAGEO CORPORATION, Kaohsiung City (TW)

(72) Inventors: Shen-Li HSIAO, Kaohsiung City (TW); Po-Hsun SHIH, Kaohsiung City (TW); Kuang-Cheng LIN, Kaohsiung City (TW)

(21) Appl. No.: 18/741,830

(22) Filed: Jun. 13, 2024

(30) Foreign Application Priority Data
Feb. 19, 2024 (TW) 113105725

(51) Int. Cl. H01C 7/00; H01C 1/148; H01C 17/075; H01C 17/28

(52) U.S. Cl. CPC H01C 7/006; H01C 1/148; H01C 17/075; H01C 17/288

(57) ABSTRACT

A thin film resistor and a method of fabricating the same are provided. The thin film resistor includes a substrate with plural recesses, a first end electrode, a second end electrode, a resistor layer and an inner electrode disposed on the resistor layer. The first end electrode is disposed on one of two end portions of an upper surface of the substrate, while the second end electrode is disposed on another one of the two end portions of an upper surface of the substrate. The resistor layer is disposed on the upper surface of the substrate and disposed within the recesses conformally. Therefore, the resistor layer can have greater surface area and longer length, thereby increasing resistance.

### CROSS-REFERENCE TO RELATED APPLICATION

This application claims priority to Taiwan Application Serial Number 113105725, filed Feb. 19, 2024, which is herein incorporated by reference.

### BACKGROUND

### Field of Invention

The present invention relates to a thin film resistor and a method of fabricating the same. More particularly, the present invention relates to the thin film resistor with high-voltage resistance and the method of fabricating the same.

### Description of Related Art

Conventional thin film chip resistor is fabricated on a ceramic substrate, and a pair of electrodes is formed on two ends of a surface of the ceramic substrate by printing. Subsequently, a resistor layer is formed by a sputter method, and the resistor layer spans a portion of the pair of electrodes, thereby forming a basic resistor module. Then, plural curved line patterns are formed in the thin film resistor layer by laser cutting process or photolithography to achieve a circuit design with high resistance.

In order to reach greater voltage usage rate under the same power, there is a choice to increase a resistance of the thin film resistor. Alternatively, if the greater voltage is desired under the same resistance, there is another choice to increase self-pressure resistance of the resistor layer or line widths of the bending resistor film, thereby reducing a current density of a surface of the resistor film.

If the resistance of a chip resistor is desired to increase with the same resistor material, there are two methods to increase the resistance according to Ohm's law, in which one of them is to reduce a thickness of the resistor layer, while another one is to increase curved line patterns. Nevertheless, the method of reducing the thickness of the resistor layer may result in decrease in power and weather resistance of a product due to too thin resistor layer, and it can be susceptible to be damaged due to electrostatic discharge and voltage surge. If the curved line patterns are increased, it will be needed to use laser or photolithography to form the curved line pattern after thickening the resistor layer. However, if the number of laser cutting is increased, spacing between lines of the curved line patterns will be too close (e.g. line width<7 μm) to affect the stability of the resistor for electrical performance due to the influence of thermal effect of the laser processing on the resistor layer itself. If the photolithography process is used to form the curved line patterns, it will be difficult to reach the desired small line width after etching, and the cost is relatively high compared to the laser process.

According to above, it is needed to provide a thin film resistor and a method of fabricating the same, thereby overcoming the above problems, increasing the curved line patterns, and further increasing the resistance of the thin film resistor.

### SUMMARY

An aspect of the present invention provides a thin film resistor, which have a resistor layer conformally disposed within recesses of a substrate, thereby forming the resistor layer with greater surface area and longer length, and further achieving the effect of increasing resistance of the thin film resistor.

Another aspect of the present invention provides a method of fabricating the thin film resistor, which forms plural recesses on a surface of the substrate by laser processing, and the resistor layer is conformally disposed on the surface of the substrate and within the recesses, thereby increasing resistance of the thin film resistor.

According to the aspect of the present invention, the thin film resistor is provided. The thin film resistor includes a substrate, in which an upper surface of the substrate has plural recesses, each of the recesses extends along a first direction of the substrate, and the recesses are arranged along a second direction; a first end electrode disposed on one of two end portions of the upper surface of the substrate, in which the two end portions are located on respective two ends along the first direction; a second end electrode disposed on another of the two end portions of the upper surface of the substrate; a resistor layer disposed on the upper surface of the substrate and disposed within the recesses conformally, in which the resistor layer is located between the first end electrode and the second end electrode; and an inner electrode disposed on the resistor layer.

According to an embodiment of the present invention, a respective minimal distance between two ends of each of the recesses and two edges of the two ends of the substrate is not smaller than ⅙ times of a length of the substrate, and the length of the substrate is a distance between the two edges of the two ends.

According to an embodiment of the present invention, a distance between one of the recesses closest to an edge of a width of the substrate and the edge of the width is not smaller than 150 μm.

According to an embodiment of the present invention, the thin film resistor further includes a passivation layer fully covered over the resistor layer; and a protection layer disposed on the passivation layer and partially covered the first end electrode and the second end electrode.

According to an embodiment of the present invention, the inner electrode includes a first portion and a second portion, the first portion covers the first end electrode, the second portion covers the second end electrode, and the first portion is separated from the second portion.

According to an embodiment of the present invention, the thin film resistor further includes a back electrode disposed on a lower surface of the substrate; and an outer electrode disposed on a side surface of the substrate, in which the outer electrode is connected to the back electrode.

According to an embodiment of the present invention, a spacing along the second direction between adjacent two of the recesses is not smaller than 7 μm.

According to an embodiment of the present invention, each of the recesses has a width not smaller than 7 μm.

According to an embodiment of the present invention, each of the recesses has a depth not smaller than 0.2 μm.

According to another aspect of the present invention, the method of fabricating the thin film resistor is provided. The method includes laser etching an upper surface of a substrate to form plural recesses, in which each of the recesses extends along a first direction of the substrate, and the recesses are arranged along a second direction; forming a first electrode pair on two end portions of the substrate, in which the two end portions are located on respective two ends along the first direction; forming a resistor layer on the upper surface of the substrate, wherein the resistor layer is disposed within the recesses conformally; forming a passivation layer on the resistor layer; and forming an inner electrode on the passivation layer.

According to an embodiment of the present invention, spacing between adjacent two of the recesses is not smaller than 7 μm.

According to an embodiment of the present invention, each of the recesses has a width not smaller than 7 μm.

According to an embodiment of the present invention, each of the recesses has a depth not smaller than 0.2 μm.

According to an embodiment of the present invention, the method further includes performing a laser trimming operation on the resistor layer after forming the resistor layer.

According to an embodiment of the present invention, the method further includes forming a protection layer on the passivation layer before forming the inner electrode; and forming the inner electrode on the protection layer.

According to the aspect of the present invention, the thin film resistor is provided. The thin film resistor includes a substrate, in which an upper surface of the substrate has plural recesses, each of the recesses extends along a first direction of the substrate, and a distance of one of two ends of each of the recesses and a nearest length edge is not smaller than ⅙ times of a length of the substrate along the first direction; an electrode pair disposed on two end portions of the substrate, in which the two end portions are located on respective two ends along the first direction; a resistor layer disposed on the substrate and disposed within the recesses conformally; and a passivation layer disposed on the resistor layer.

According to an embodiment of the present invention, the recesses are arranged along a second direction, and the second direction is perpendicular to the first direction.

According to an embodiment of the present invention, a spacing along the second direction between adjacent two of the recesses is not smaller than 7 μm.

According to an embodiment of the present invention, each of the recesses has a width not smaller than 7 μm and a depth not smaller than 0.2 μm.

According to an embodiment of the present invention, a distance between one of the recesses closest to an edge of a width of the substrate and the edge of the width is not smaller than 150 μm.

With the application of the thin film resistor and the method of fabricating the same, the plural recesses are formed on the surface of the substrate by steps of laser processing, and the resistor layer is formed on the surface of the substrate and within the recesses conformally. Therefore, the resistor layer can have greater surface area and longer length, thereby increasing the resistance and having better resistance to high voltage and high current of thin film resistor.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a stereo diagram of the thin film resistor according to some embodiments of the present invention.

FIG. 2A illustrates a sectional view along line A-A in FIG. 1.

FIG. 2B illustrates a sectional view along line B-B in FIG. 1.

FIG. 2C illustrates a top view of the thin film resistor according to some embodiments of the present invention.

FIGS. 3A to 3E illustrate top views of intermediate stages of a process of fabricating the thin film resistor according to some embodiments of the present invention.

### DETAILED DESCRIPTION

The following disclosure provides many different embodiments, or examples, for implementing different features of the present invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, “around,” “about,” “approximately,” or “substantially” shall generally mean within 20 percent, or within 10 percent, or within 5 percent of a given value or range.

Generally, a chip resistor has a rated power and a maximum operating voltage marked in a product specification. The rule defines when the resistance of the product is greater than a specific resistance, the product is only suitable the maximum operating voltage but not suitable for the rated power. Under the same rated power, if a withstand voltage of the product is desired to be increased, a resistor path should be increased. That is, more bending line pattern should be formed, thereby reducing a voltage of the resistor circuit, and decreasing voltage difference of unit length. However, according to ohm's law, increasing the resistor path would reduce a cross-sectional area of the path, and thus, a power stability of the product would be reduced. Therefore, the present invention provides a thin film resistor and a method of fabricating the same, which uses laser processing to form plural recesses on the surface of the substrate, and the resistor layer is conformally disposed on the surface of the substrate and within the recesses. Thus, the resistor layer can have greater surface area and longer length, thereby increasing the resistance and having greater resistance to high voltage and high current of the thin film resistor.

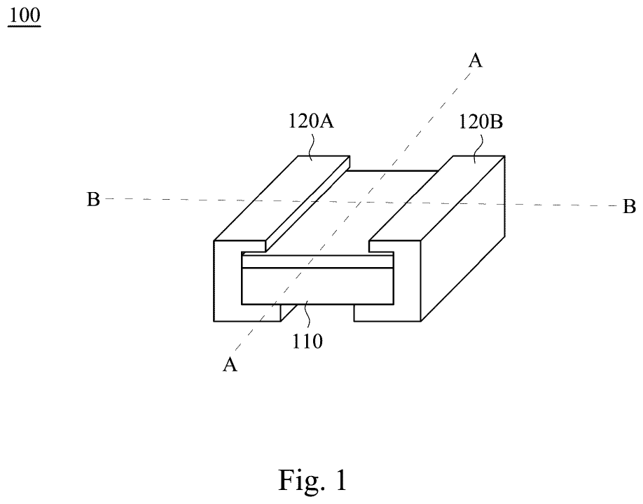

Referring to FIG. 1, FIG. 1 illustrates a stereo diagram of the thin film resistor 100 according to some embodiments of the present invention. The thin film resistor 100 includes a substrate 110, a first end electrode 120A and a second end electrode 120B, in which the first end electrode 120A and the second end electrode 120B are disposed on two end portions of the substrate 110, respectively. In some embodiments, material of the substrate 110 can be aluminum oxide, aluminum nitride, ceramic glass, and etc. In some embodiments, the first end electrode 120A and the second end electrode 120B are formed of glass, silver, electrode paste mixed with silver and palladium, or copper.

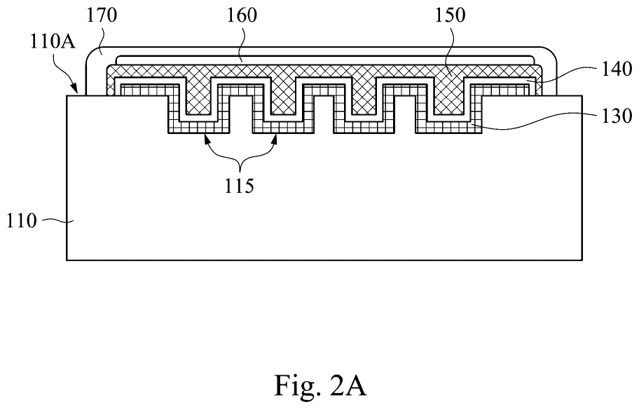

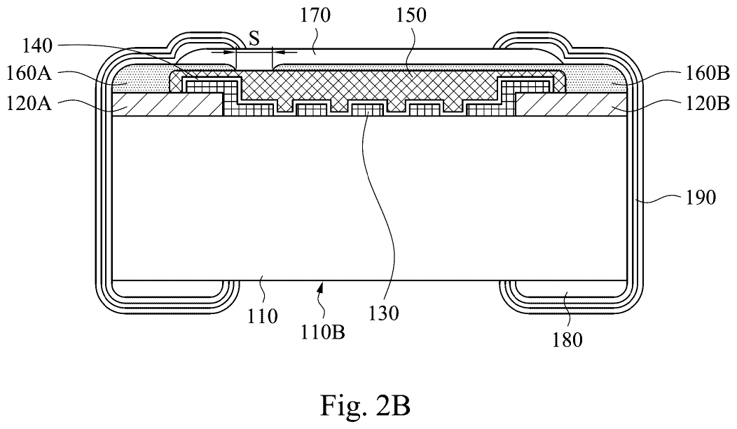

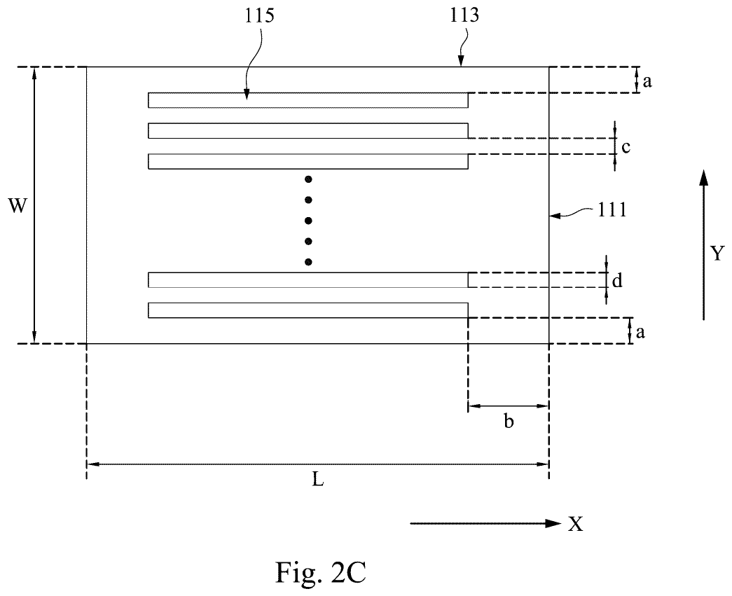

FIG. 2A illustrates a sectional view along line A-A in FIG. 1, and FIG. 2B a sectional view along line B-B in FIG. 1. Referring to FIGS. 2A and 2B, there are numbers of recesses 115 on an upper surface 110A of the substrate 110 of the thin film resistor 100. The thin film resistor 100 includes a resistor layer 130, and the resistor layer 130 is disposed on the upper surface 110A of the substrate 110 and is conformally disposed within the recesses 115. That is, the resistor layer forms a wavy film along the recesses 115. As a result, the resistor layer 130 can have greater surface area and longer path with the same area of the substrate, thereby increasing the resistance of the thin film resistor 100. In addition, the resistor layer 130 is located between the first end electrode 120A and the second end electrode 120B. In some embodiments, as shown in FIG. 2B, the resistor layer 130 is partially disposed on portions of the first end electrode 120A and the second end electrode 120B.

FIG. 2C illustrates a top view of the thin film resistor according to some embodiments of the present invention. Most of components of the thin film resistor 100 are omitted in FIG. 2C for illustrating shapes of the recesses 115. The substrate 110 has a length L and a width W. As shown in FIG. 2C, each of the recesses 115 extends along a first direction X (i.e. lengthwise direction). In some embodiments, a distance b between two ends of the recesses 115 and lengthwise edges 111 of the substrate 110 is not smaller than ⅙ times of the length L of the substrate 110, and preferably, the distance b is between about ⅙L to about ½L (i.e. ½L≤b≤⅙L). When the distance b is within the above range, an electrode paste can be prevented from flowing into the recesses 115 during process of forming the electrodes.

The plural recesses 115 are arranged along a second direction Y (i.e. lateral direction) of the substrate 110. In some embodiments, a distance a between the recess 115 closest to an edge of a width 113 of the substrate and the edge of the width 113 is not smaller than about 150 μm, and preferable, the distance a is between about 150 μm and ½ times of the width W (i.e. 150 μm≤ a≤½W). The distance a should be within the above range because of setup requirements of a passivation layer and a protection layer, and the passivation layer and the protection layer will be discussed in detail in the following.

Since the recesses 115 are formed by using laser processing, in some embodiments, a spacing c between adjacent two of the recesses 115 is not smaller than about 7 μm, and preferably, the spacing c is between about 7 μm and ⅓ times of the width W (i.e. 7 μm≤c≤⅓W). In some embodiments, a width d of the recesses 115 is not smaller than about 7 μm, and preferably, the width d is between about 7 μm and about 20 μm (i.e. 7 μm≤d≤20 μm). In some embodiments, a depth t of the recesses is not smaller than 0.2 μm, and preferably, the depth t is between about 0.2 μm and about 3 μm (i.e. 0.2 μm≤t≤3 μm). When the depth t is within the above range, the path of the resistor layer 130 can be effectively increased, and the resistor layer 130 can be effectively connected.

Referring to FIGS. 2A and 2B again, in some embodiments, the thin film resistor 100 further includes a passivation layer 140 and a protection layer 150, in which the passivation layer 140 fully covers the resistor layer 130. That is, the passivation layer 140 is conformally disposed on the resistor layer 130. In some embodiments, the passivation layer 140 is formed of silicon oxide, tantalum oxide, silicon nitride or combinations thereof. The protection layer 150 is disposed on the passivation layer 140, and fully covers the passivation layer 140. In addition, as shown in FIG. 2B, the protection layer 150 further partially covers the first end electrode 120A and the second end electrode 120B. In some embodiments, as shown in FIG. 2A, the protection layer 150 is partially filled into the recesses 115. In some embodiments, the protection layer 150 is formed by epoxy resin or resin.

The thin film resistor 100 includes an inner electrode 160 disposed on the protection layer 150. In some embodiments, as shown in FIG. 2B, the inner electrode 160 includes a first portion 160A and a second portion 160B, in which the first portion 160A partially covers the first end electrode 120A, and the second portion 160B partially covers the second end electrode 120B. The first portion 160A and the second portion 160B are not connected to each other, thereby avoiding short circuit. In some embodiments, spacing S between the first portion 160A separated from the second portion 160B is not smaller than 50 μm. In some embodiments, the first portion 160A and the second portion 160B have different size, such that a separating position of the first portion 160A and the second portion 160B is not located at center of the thin film resistor 100.

In some embodiments, the thin film resistor 100 further includes an insulating protection layer 170. The insulating protection layer 170 is disposed on the inner electrode 160 and the protection layer 150. Similar to the protection layer 150, the material of the insulating protection layer 170 can be epoxy resin or resin.

The thin film resistor 100 further includes back electrodes 180 and outer electrodes 190. The back electrodes 180 are disposed on a lower surface 110B of the substrate 110, and the outer electrodes 190 are disposed on lateral surfaces of the substrate 110. In some embodiments, the outer electrodes 190 are connected to the back electrodes 180. In some embodiments, the back electrodes 180 are formed from combination of epoxy resin and silver.

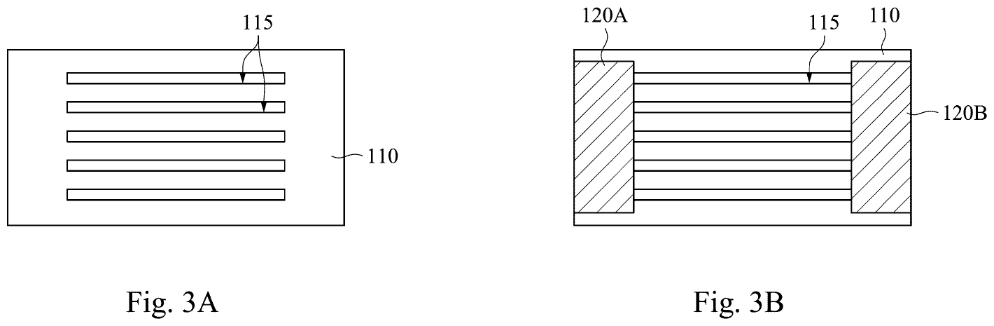

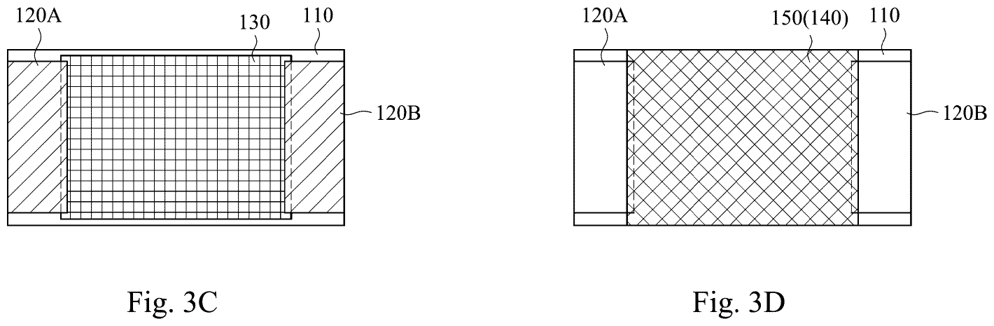

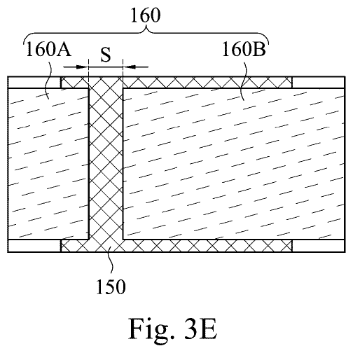

FIGS. 3A to 3E illustrate top views of intermediate stages of a process of fabricating the thin film resistor 100 according to some embodiments of the present invention. The process of fabricating the thin film resistor 100 is discussed in the following by FIGS. 3A to 3E. First, referring to FIG. 3A, the upper surface of the substrate 110 is laser etched to form plural recesses 115. The depth t, the width d, the spacing c and the distances disposed on the substrate 110 of the recesses are discussed as above, it is not repeated herein.

Subsequently, referring to FIG. 3B, an electrode pair (i.e. the first end electrode 120A and the second end electrode 120B) is formed on the two end portions of the substrate 110. In some embodiments, when the material of the first electrode pair is glass, silver or electrode paste of silver and palladium, it is formed by using printing or sintering. In other embodiments, when the material of the first electrode pair is copper, it can be formed by sputtering.

Next, a removable blocking layer (or a mask) can be formed by printing or photolithography, so as to expose areas for sputtering the resistor layer 130 and portions of the first end electrode 120A and the second end electrode 120B. Then, as shown in FIG. 3C, the resistor layer 130 is formed on the upper surface of the substrate 110 and portions of the first end electrode 120A and the second end electrode 120B. In some embodiments, the resistor layer 130 is formed by sputtering. In some embodiments, the material of the resistor layer 130 includes but are not limited to nickel-chromium (NiCr), copper-nickel (CuNi), nickel-chromium-silicon (NiCrSi), nickel-chromium-aluminum (NiCrAl), nickel-chromium-aluminum-silicon (NiCrAlSi), nickel-chromium-aluminum-Yttrium (NiCrAlY), nickel-chromium-tantalum-molybdenum (NiCrTaMo), tantalum nitride (TaN), copper-manganese-tin (CuMnSn), copper-manganese-nickel (CuMnNi), gold or other suitable resistor material.

Hereafter, the blocking layer is removed by a stripper solution. In some embodiments, a laser trimming step can be performed on the resistor layer 130 after forming the resistor layer 130, which can adjust resistance value of the resistor by laser or a physical processing.

In some embodiments, another blocking layer can be formed on the first end electrode 120A and the second end electrode 120B by printing or photolithography. Then, the passivation layer 140 is formed on the resistor layer 130. In some embodiments, the passivation layer 140 is formed by sputtering or chemical vapor deposition (CVD). Similarly, the blocking layer is removed by the stripper solution. Thereafter, the protection layer 150 is formed on the passivation layer 140, and the protection layer 150 fully covers the passivation layer 140, and partially covers the first end electrode 120A and the second end electrode 120B, as shown in FIG. 3D. In some embodiments, the protection layer 150 can be formed by printing or photolithography.

Subsequently, referring to FIG. 3E, the inner electrode 160 is formed on the protection layer 150, the first end electrode 120A and the second end electrode 120B. The inner electrode 160 includes the first portion 160A and the second portion 160B, in which the first portion 160A is separated from the second portion 160B, and a portion of the protection layer 150 is exposed. In some embodiments, the inner electrode 160 is formed by printing, and the material can be a resin electrode composed of epoxy resin and silver.

In some embodiments, the insulating protection layer 170 (see FIG. 2A) can be formed by printing or photolithography afterwards. Then, the back electrode 180 (see FIG. 2B) can be formed on the lower surface 110B of the substrate 110 by printing. Subsequently, a connecting layer can be formed on the lateral surfaces of the substrate 110 by sputtering nickel-chromium alloy, and the outer electrode 190 (see FIG. 2B) of a nickel layer and a tin layer is formed in order by electroplating.

According to above, the present invention provides the thin film resistor and the method of fabricating the same, which uses laser processing to form plural recesses on the surface of the substrate, and the resistor layer is conformally disposed on the surface of the substrate and within the recesses. Thus, the resistor layer can have greater surface area and longer length, thereby increasing the resistance and having greater resistance to high voltage and high current of the thin film resistor.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A thin film resistor, comprising:
a substrate, wherein an upper surface of the substrate has a plurality of recesses, each of the recesses extends along a first direction of the substrate, and the recesses are arranged along a second direction;
a first end electrode, disposed on one of two end portions of the upper surface of the substrate, wherein the two end portions are located on respective two ends along the first direction;
a second end electrode, disposed on another of the two end portions of the upper surface of the substrate;
a resistor layer, disposed on the upper surface of the substrate and disposed within the recesses conformally, wherein the resistor layer is located between the first end electrode and the second end electrode; and
an inner electrode, disposed on the resistor layer.

2. The thin film resistor of claim 1, wherein a respective minimal distance between two ends of each of the recesses and two edges of the two ends of the substrate is not smaller than ⅙ times of a length of the substrate, and the length of the substrate is a distance between the two edges of the two ends.

3. The thin film resistor of claim 1, wherein a distance between one of the recesses closest to an edge of a width of the substrate and the edge of the width is not smaller than 150 μm.

4. The thin film resistor of claim 1, further comprising:
a passivation layer, fully covered over the resistor layer; and
a protection layer, disposed on the passivation layer and partially covered the first end electrode and the second end electrode.

5. The thin film resistor of claim 1, wherein the inner electrode comprises a first portion and a second portion, the first portion covers the first end electrode, the second portion covers the second end electrode, and the first portion is separated from the second portion.

6. The thin film resistor of claim 1, further comprising:
a back electrode, disposed on a lower surface of the substrate; and
an outer electrode, disposed on a side surface of the substrate, wherein the outer electrode is connected to the back electrode.

7. The thin film resistor of claim 1, wherein a spacing along the second direction between adjacent two of the recesses is not smaller than 7 μm.

8. The thin film resistor of claim 7, wherein each of the recesses has a width not smaller than 7 μm.

9. The thin film resistor of claim 7, wherein each of the recesses has a depth not smaller than 0.2 μm.

10. A method of fabricating a thin film resistor, comprising:
laser etching an upper surface of a substrate to form a plurality of recesses, wherein each of the recesses extends along a first direction of the substrate, and the recesses are arranged along a second direction;
forming a first electrode pair on two end portions of the substrate, wherein the two end portions are located on respective two ends along the first direction;
forming a resistor layer on the upper surface of the substrate, wherein the resistor layer is disposed within the recesses conformally;
forming a passivation layer on the resistor layer; and
forming an inner electrode on the passivation layer.

11. The method of fabricating the thin film resistor of claim 10, wherein a spacing between adjacent two of the recesses is not smaller than 7 μm.

12. The method of fabricating the thin film resistor of claim 10, wherein each of the recesses has a width not smaller than 7 μm.

13. The method of fabricating the thin film resistor of claim 10, wherein each of the recesses has a depth not smaller than 0.2 μm.

14. The method of fabricating the thin film resistor of claim 10, further comprising:
performing a laser trimming operation on the resistor layer after forming the resistor layer.

15. The method of fabricating the thin film resistor of claim 10, further comprising:
forming a protection layer on the passivation layer before forming the inner electrode; and
forming the inner electrode on the protection layer.

16. A thin film resistor, comprising:
a substrate, wherein an upper surface of the substrate has a plurality of recesses, each of the recesses extends along a first direction of the substrate, and a distance of one of two ends of each of the recesses and a nearest length edge is not smaller than ⅙ times of a length of the substrate along the first direction;
an electrode pair, disposed on two end portions of the substrate, wherein the two end portions are located on respective two ends along the first direction;
a resistor layer, disposed on the substrate and disposed within the recesses conformally; and
a passivation layer, disposed on the resistor layer.

17. The thin film resistor of claim 16, wherein the recesses are arranged along a second direction, and the second direction is perpendicular to the first direction.

18. The thin film resistor of claim 17, wherein a spacing along the second direction between adjacent two of the recesses is not smaller than 7 μm.

19. The thin film resistor of claim 16, wherein each of the recesses has a width not smaller than 7 μm and a depth not smaller than 0.2 μm.

20. The thin film resistor of claim 16, wherein a distance between one of the recesses closest to an edge of a width of the substrate and the edge of the width is not smaller than 150 μm.
